(19) United States
(12) Patent Application Publication
(10) Pub. No.: US 2024/0072665 A1
(43) Pub. Date: Feb. 29, 2024

(54) DC-TO-DC POWER CONVERSION SYSTEM

(71) Applicants: Arti Bhardwaj, Bangalore (IN); Yogesh Bhardwaj, Bangalore (IN)

(72) Inventors: Arti Bhardwaj, Bangalore (IN); Yogesh Bhardwaj, Bangalore (IN)

(21) Appl. No.: 18/236,414

(22) Filed: Aug. 22, 2023

(30) Foreign Application Priority Data
Aug. 24, 2022 (IN) 202241048219

(51) Int. Cl. H02M 3/158; H02J 1/10; H02M 1/088

(52) U.S. Cl. CPC H02M 3/158; H02J 1/102; H02M 1/088; H02J 2300/24

(57) ABSTRACT

A DC-to DC power conversion system (100) comprising a first DC input (21), an auxiliary DC input (22), a switching module (25), a boost module (30), and a control module (10). At least one renewal energy-based first input source is providing the first DC input (21). The switching module (25) is in electrical communication with the first DC input (21) and the auxiliary DC input (22). The boost module (30) is in electrical communication with the switching module DC output (50). The control module (10) controls the boost module (30) based on the magnitude of first DC input (21) from the renewal energy-based first input source, to selectively operate a control circuitry and provide an output therefrom acting as an input to an external DC load (50). This invention ensures direct DC-DC power conversion without involving any kind of AC conversion thereby saving huge electric power losses.

### FIELD OF THE INVENTION

The present invention generally relates to electrical power systems, and, more particularly, to a DC-to-DC power conversion system.

### BACKGROUND OF THE INVENTION

With rapid globalization, human activity has expanded exponentially. Human activity is significantly dependent on energy. A major contribution of energy generation is coming from non-renewable sources. With every day, the demand for energy is increasing, and to satisfy the growing demands energy production has also increased manifold. This is, inter alia, resulting in global warming. This entire loop was inevitable until renewable sources are bought into the mainstream.

Energy generation can also be done from renewable sources of energy such as wind energy, solar energy, tidal energy, geothermal energy, and so forth. These renewable sources of energy have made it possible for the distribution and availability of electricity in remote areas especially solar panels. As the solar panels convert solar energy to electrical energy, this electrical energy can be set up and supplied independently. Also, solar energy is lauded as an inexhaustible fuel source that is pollution-free and often noise free. Solar energy can charge storage batteries throughout the day using the sun's rays and provide hours of light after dark.

However, these renewable sources of energy are not reliable as they are majorly dependent upon natural activities. For example, the power generated by solar panels in the rainy season is comparatively lower than power generated in the summer season. Moreover, in present-day of the world, an uninterrupted supply of electricity is much needed, and to achieve it, solar systems lack as sunlight is limited for a specified duration. But solar energy “does not” work at night without a storage device such as a battery, and cloudy weather can make the technology unreliable during the day. Further, these renewable sources of energy are expensive and add further loss during transmission and distribution.

Numerous prior arts have made attempts to develop a device and a system for eliminating wastage of generated Solar Renewable DC power through conversion and distribution with numerous prototyping but haven't achieved a more desirable feature in a single unit for the power conversion and distribution device and system.

In general, solar energy is often considered as one of the most deployable forms of renewable energy resource. Recently, the trend of hydrogen is emerging as one form of renewable energy source. However, in present times, generation of energy from hydrogen is costly affair. Although, hydrogen is having a potential to be developed as an alternate or substitute of the fuel resources in industries like automotive, power, fertilizer production, Industrial usage like green steel and green aluminum & metal production etc. The whole reasoning behind the usage of hydrogen is to achieve the net zero condition. However, the net zero condition is not getting achieved due to production of the hydrogen through running of the electrolyzers. Although, efforts are being made to do hydrogen generation through net zero means by incorporating solar, Wind and green energy in linkage with the electrolyzers.

Broadly, to supply solar power to the electrolyzers. The solar power plants are developed. Traditionally, in solar power plants, the solar power plants comprise a plurality of solar module. The plurality of solar module is used to produce DC power. After production of DC power from the solar module, the DC power is collected in a DC array box. From the DC array box, the DC power goes to a solar or PV Inverter which converts DC power into AC power. Then there is a transformer to do the step-up according to the grid voltage. Then there is a switch gear and other related systems for the monitoring and control which supply power to blocks and the combination of these power blocks forms a plant sub-station. There are AC plurality of transmission lines to get this power into the transmission grid and further distribution set up for step-down the power voltage. Finally, for supplying the power to the electrolyzers, the power is converted from AC power into DC power using Rectifier cum converters. Overall, this whole power conversion from renewable DC power to AC power and then AC power to DC power, there is a wastage of Energy in the order of about 5% of overall electric power. This is a significant loss of electric power. The elimination of this much electric power loss appears to be a herculean task.

Further, for efficient working of the electrolyzers, continuity of power supply is a sine-qua-non. However, while operating the electrolyzers by solar power or any other form of renewable source of energy getting the continuity of power supply is a challenge. This challenge needs to be overcome for ensuring bigger reach to renewable energy sources.

In a prior art U.S. Ser. No. 11/183,839B2 with title DC-DC power conversion system discloses a power conversion system configured to provide a power output from an arrangement of direct current (DC) power sources. One example power conversion system includes multiple power sources PV(n), n=1 to x, connected in a series. For each power source PV(n) for n=1 to x−1, the power conversion system includes an intermediate bidirectional voltage converter VC(n) connected to a first terminal of the power source PV(n), a first terminal of power source PV(x), and a second terminal of power source PV(1). Each intermediate bidirectional voltage converter VC(n) includes a first switch operable in a pulsed mode to boost a power output by power source PV(n) and a second switch operable in a pulsed mode to reduce a power output by power source PV(n). The power conversion system also includes a balancer VC(x) connected to the first terminal of PV(x) and to a load. However, the disclosed prior-art failed to address the issue related to ensure DC-DC power conversion for High voltage system without any significant power loss and also failed to ensure continuous supply of power while DC-DC power conversion.

Background description includes information that may be useful in understanding the present invention. It is not an admission that any of the information provided herein is prior art or relevant to the presently claimed invention, or that any publication specifically or implicitly referenced is prior art.

### SUMMARY OF THE INVENTION

In view of the problems in the prior art, an object of the present invention is to provide a DC-to DC power conversion system with DC storage system.

A DC-to DC power conversion system is disclosed according to one aspect of the present invention. The DC-to DC power conversion system comprises a first DC input, an auxiliary DC input, a switching module, a boost module, and a control module. At least one renewal energy-based first input source is providing DC power as the first DC input. A rechargeable energy storage device is adapted to provide the auxiliary DC power as the auxiliary DC input. The switching module is in electrical communication with each of the renewal energy-based first input source and the rechargeable energy storage device to receive the first DC input and the auxiliary DC input respectively, and provide a switching module DC output. The boost module is in electrical communication with the switching module DC output, the boost module is having a control circuitry. The control module is for controlling each of the switching module and the boost module. The control module is being adapted to operate the switching module to selectively enable charging of the rechargeable energy storage device from the renewal energy-based first DC input. The control module is being adapted to control the boost module based on the magnitude of first DC input from the renewal energy-based first input source, to selectively operate the control circuitry and provide an output therefrom acting as an input to an external DC load.

As per the embodiment of the invention, the control circuitry of the boost module includes a plurality of switching elements arranged in series or parallel according to the load of consuming equipment.

As per the embodiment of the invention, each of the plurality of switching elements are adapted to be controlled individually and independent of one another.

As per the embodiment of the invention, each of the plurality of switching elements include IGBT power modules components/devices & associated components and firmware control systems.

As per the embodiment of the invention, a measurement module is provided that is adapted to continuously measure the magnitude of the first DC input, and the switching module DC output, the measurement module being in communication with the control module.

As per the embodiment of the invention, when the magnitude of the first DC input is measured to be in a first input range, the control module operates the switching module such that all of the first DC input is passed to the boost module as the switching module DC output.

As per the embodiment of the invention, when the magnitude of the first DC input is measured to be in a second input range, the control module operates the switching module such that all of the first DC input and the auxiliary DC input is passed to the boost module as the switching module DC output.

As per the embodiment of the invention, when the magnitude of the first DC input is measured to be in a third input range, the control module operates the switching module such that a portion of the first DC input is passed to the boost module as the switching module DC output and another portion of the first DC input is passed to the rechargeable Bi-directional energy storage batteries/device.

As per the embodiment of the invention, based on the value of the switching module DC output, the switching elements of the boost module are operated such that the output therefrom is at least at a threshold value required by the external DC load, wherein when the value of the switching module DC output is measured to be in a first output range, all of the switching elements are closed whereby all of the switching module DC output is boosted to reach at least at a threshold value required by the external DC load, and when the value of the switching module DC output is measured to be in a second output range, a set of switching elements are opened whereby a portion of the switching module DC output is boosted to reach at least at a threshold value required by the external DC load.

As per the embodiment of the invention, the renewal energy-based first input source is one of solar and wind energy based.

As per the embodiment of the invention, the external DC load is a Hydrogen electrolyzer and any of the industrial, telecom or data center loads.

In accordance with another embodiment of the present invention, a DC-to-DC power conversion system comprises a first DC input, an auxiliary DC input, a switching module, a boost module, and a control module. The switching module is in electrical communication with each of the first DC input and the auxiliary DC input respectively and provides a switching module DC output. The boost module is in electrical communication with the switching module DC output, the boost module is having a control circuitry. The control module is for controlling each of the switching module and the boost module. The control module is being adapted to operate the switching module to selectively enable charging of the rechargeable energy storage device from the renewal energy-based first DC input. The control module is being adapted to control the boost module based on the magnitude of the first DC input from the renewal energy-based first input source, to selectively operate the control circuitry and provide an output therefrom acting as an input to an external DC load.

As per the embodiment of the invention, the control circuitry of the boost module includes a plurality of switching elements arranged in series or parallel, according to requirement.

As per the embodiment of the invention, each of the plurality of switching elements are adapted to be controlled individually and independent of one another.

As per the embodiment of the invention, each of the plurality of switching elements include IGBT modules.

As per the embodiment of the invention, each a measurement module is adapted to continuously measure the magnitude of the first DC input, and the switching module DC output, the measurement module being in communication with the control module, wherein when the magnitude of the first DC input is measured to be in a first input range, the control module operates the switching module such that all of the first DC input is passed to the boost module as the switching module DC output.

In accordance with an embodiment of the present invention, a method for converting DC to DC power is disclosed. The method comprising following steps. Firstly, receiving a first DC input from a renewal energy-based first input source. Secondly, receiving an auxiliary DC input from a rechargeable energy storage device. Thirdly, measuring values of the first DC input, and the auxiliary DC input. Fourthly, passing one or more of the first DC input, and the auxiliary DC input to a boost module, the boost module having a plurality of switching elements arranged in series or parallel. Fifthly, operating switching elements, based on a required DC output at an external load, to boost the one or more of the first DC input and the auxiliary DC input, passing therethrough. Finally, providing the required DC output to the external load.

As per the embodiment of the invention, the method for converting DC to DC power having the step of operating switching elements includes operating a set of switching elements periodically for a predetermined period of time, so that output therefrom is at least at a threshold value required by the external DC load.

The present invention has the economic and single unit DC-to DC power conversion system for ensuring the highest accurate efficient power conversion in optimized time period.

The present invention has portable DC power conversion device along with the integration of a storage battery to ensure foolproof continuous DC-DC power conversion and supply to various DC input driven systems irrespective of their requirements.

The present invention ensures direct DC-DC power conversion without involving any kind of AC conversion thereby saving huge electric power losses, with lesser components, thereby improving reliability and saving on the overall capital cost also.

The present invention makes the DC power coming out from renewable sources of energy as reliable by ensuring a continuous supply of power irrespective of variation in nature affecting the renewable sources of energy.

The present invention provides an efficient DC-to DC power conversion system to be used in the Renewable Energy, Green hydrogen production, Industrial, IT and Telecom Industry.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below. Features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 illustrates a block configuration of DC power converter according to an embodiment;

FIG. 2a illustrates a block configuration of DC-to DC power conversion system and device according to an embodiment;

FIG. 2b illustrates another block configuration of DC-to DC power conversion system and device according to an embodiment;

FIG. 3 illustrates a functional configuration of DC power supply system according to an embodiment;

FIG. 4 exemplarily shows a DC power supply device with a battery storage according to an embodiment;

FIG. 5 illustrates essential internal components of the DC power converter according to an embodiment;

FIG. 6 illustrates a block diagram of a DC power supply system and device with a hydrogen electrolyzer according to an embodiment; and

FIG. 7 exemplarily shows the DC power supply system and device with the hydrogen electrolyzer according to an embodiment.

Like reference numerals refer to like parts throughout the description of several views of the drawing.

### DESCRIPTION OF EMBODIMENTS

Hereinafter, embodiments of the present invention will be described with reference to the drawings. The components described in these embodiments are merely examples and are not limited by the following embodiments.

If the specification states a component or feature “may”, “can”, “could”, or “might” be included or have a characteristic, that particular component or feature is not required to be included or have the characteristic.

In some embodiments, the numbers expressing quantities of ingredients, properties such as concentration, reaction conditions, and so forth, used to describe and claim certain embodiments of the invention are to be understood as being modified in some instances by the term “about”. Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context.

The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

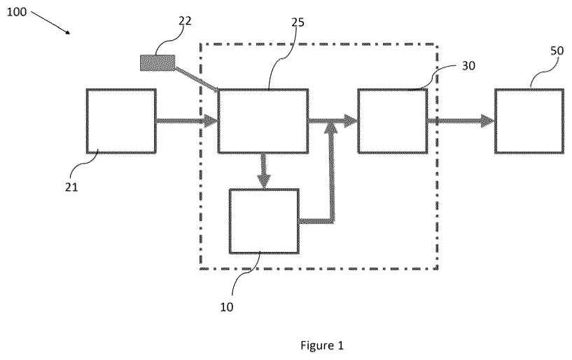

Referring to FIG. 1 to FIG. 7, a DC-to DC power conversion system (100) comprising a first DC input (21), an auxiliary DC input (22), a switching module (25), a boost module (30), and a control module (10). The auxiliary DC input (22) in one embodiment, is adapted to provide power for control and communication components and devices. At least one renewal energy-based first input source is providing DC power as the first DC input (21). A rechargeable energy storage batteries or devices is adapted to provide the auxiliary DC power as the auxiliary DC input (22). The switching module (25) is in electrical communication with each of the renewal energy-based first input source and the rechargeable energy storage device to receive the first DC input (21) and the auxiliary DC input (22) respectively, and provide a switching module DC output. The boost module (30) is in electrical communication and control with the switching module DC output (50), the boost module (30) having a control circuitry. The control module (10) is for controlling each of the switching module and the boost module (30). The control module (10) being adapted to operate the switching module (25) to selectively enable charging of the rechargeable energy storage batteries or devices from the renewal energy-based first DC input (21). The control module (10) is being adapted to control the boost module (30) based on the magnitude of first DC input (21) from the renewal energy-based first input source, to selectively operate the control circuitry and provide an output therefrom acting as an input to an external DC load (50).

The control circuitry of the boost module (30) includes a plurality of switching elements arranged in series or parallel as needed. Each of the plurality of switching elements are adapted to be controlled individually and independent of one another. Each of the plurality of switching elements include IGBT power modules components/devices & associated components and firmware control systems.

A measurement module is adapted to continuously measure the magnitude of the first DC input (21), and the switching module DC output, the measurement module (25) being in communication with the control module (10). The magnitude of the first DC input (21) is measured to be in a first input range, the control module (10) operates the switching module (25) such that all of the first DC input (21) is passed to the boost module (30) as the switching module DC output. More particularly, the renewal energy-based first input source is one of solar and wind energy based. In an example, the external DC load (50) is a Hydrogen electrolyzer and any of the industrial, telecom or Data center loads.

Further, when the magnitude of the first DC input (21) is measured to be in a second input range, the control module (10) operates the switching module (25) such that all of the first DC input (21) and the auxiliary DC input (22) is passed to the boost module (30) as the switching module DC output. Also, when the magnitude of the first DC input (21) is measured to be in a third input range, the control module (10) operates the switching module (25) such that a portion of the first DC input (21) is passed to the boost module (30) as the switching module DC output and another portion of the first DC input (21) is passed to the rechargeable Bi-directional energy storage batteries/device.

Based on the value of the switching module DC output, the switching elements of the boost module (30) are operated such that the output therefrom is at least at a threshold value required by the external DC load (50), wherein when the value of the switching module DC output is measured to be in a first output range, all of the switching elements are closed whereby all of the switching module DC output is boosted to reach at least at a threshold value required by the external DC load (50), and when the value of the switching module DC output is measured to be in a second output range, a set of switching elements are opened whereby a portion of the switching module DC output is boosted to reach at least at a threshold value required by the external DC load (50).

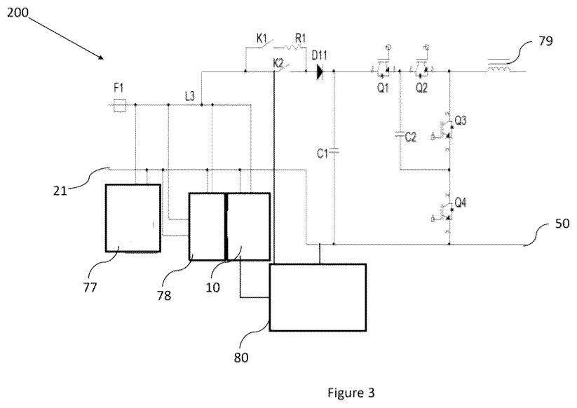

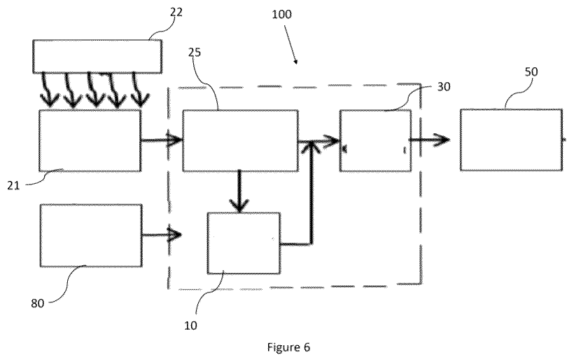

Referring to FIG. 1, FIG. 3 and FIG. 6, a method for converting DC to DC power is disclosed. The method comprises following steps. Firstly, receiving a first DC input (21) from a renewal energy-based first input source. Secondly, receiving an auxiliary DC input (22) from a rechargeable energy storage device. Thirdly, measuring values of the first DC input, and the auxiliary DC input. Fourthly, passing one or more of the first DC input (21), and the auxiliary DC input (22) to a boost module (30), the boost module having a plurality of switching elements arranged in series or parallel. Fifthly, operating switching elements, based on a required DC output at an external load, to boost the one or more of the first DC input (21) and the auxiliary DC input (22), passing therethrough. Finally, providing the required DC output to the external load (50). The step of operating switching elements includes operating a set of switching elements periodically for a predetermined period of time, so that output therefrom is at least at a threshold value required by the external DC load (50).

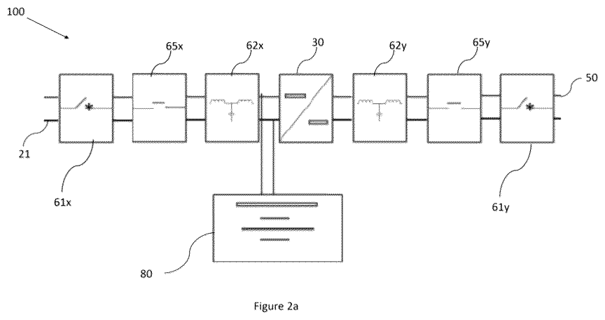

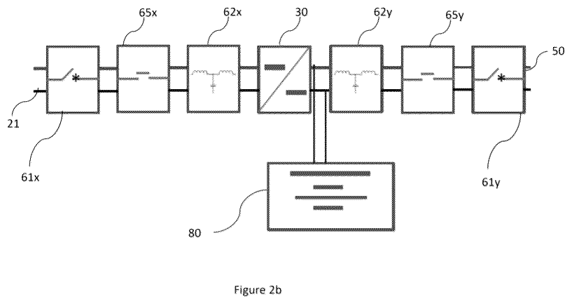

Referring to FIG. 2a and FIG. 2b, the DC-to DC power conversion system (100) comprises the DC input (21), the DC output (50), a storage battery (80), a pair of fuse (61x, 61y), a pair of contactor (65x, 65y), a pair of DC EMI filter (62x, 62y) and the boost converter (30). As depicted, the DC-to DC power conversion system (100) is having three input system. All three input systems are based on DC input. The first one is DC input source power (21). The second one is bi-directional DC battery storage (80) and the third one is output load (50). The DC inputs are coming from renewable power sources such as solar energy, wind energy etc. Further, in FIG. 2a, the storage battery (80) is connected ahead of the boost converter (30). In FIG. 2b, the storage battery (80) is connected after the boost converter (30).

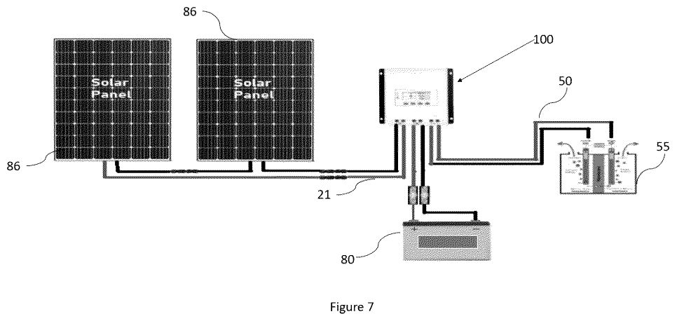

Referring to FIG. 3, a DC-DC power supply function diagram is illustrated. In accordance with FIG. 3, the portable DC power converter device (200) comprises a protective device (F1), a blocking or delay device (D1), a pair of disconnect switches or relays (K1, K2), at-least one inductor (L3), a plurality of switching device (Q1, Q2, Q3, Q4), a pair of capacitors (C1, C2), a battery storage (80), a control module (10), an insulation monitoring (77), a resistor (R1), an input filter board (78), a three level buck (79), the first DC input (21) and the DC output which is getting connected with the external DC load (50). The pair of relays (K1, K2) and the plurality of switching device (Q1, Q2, Q3, Q4) ensures that the constant DC power output is delivered from the portable DC power converter device (200) for efficient working of the external DC loads like electrolyzers (55—shown in FIG. 7).

For instance, to initiate the working of the electrolyzer (55), the threshold value of electric power is 400 KW. However, when the at least one renewal energy-based first input source, such as a solar panel (86) generates the DC input power (21), in morning or in evening then the portable DC power converter device (200) is unable to meet the desired threshold value. But, with the present invention, the excess generated DC power from the solar panel (86) during peak hours is stored in the battery storage (80) and the stored DC power is utilized in morning and evening time by the electrolyzer (55) through engagement and disengagement of the pair of relays (K1, K2) and the plurality of switching device (Q1, Q2, Q3, Q4) to regularly achieve the threshold value for the optimized operation of electrolyzer (55) continuously irrespective of the natural conditions. Hence, with the present invention, the DC power converter device (200) becomes capable to be workable in all environmental condition.

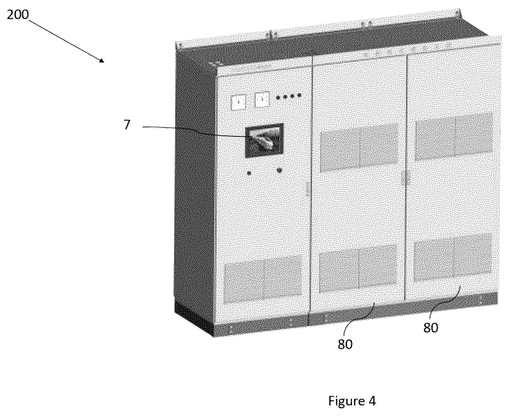

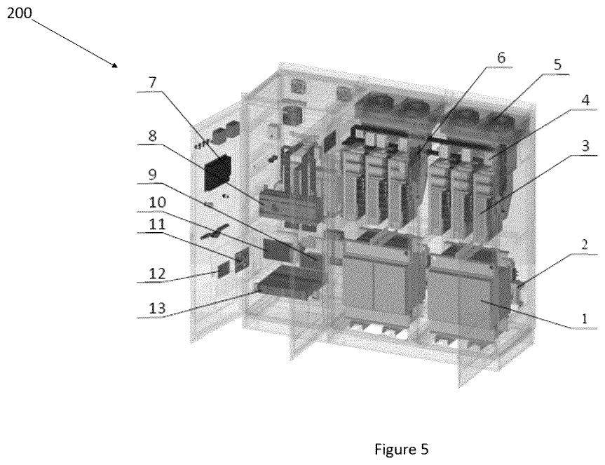

Referring to FIG. 4 and FIG. 5, the present invention having the portable DC power converter device (200) along with the integration of the battery (80) to ensure foolproof DC-DC power conversion and supply to various dc input driven systems irrespective of their requirements. As shown, the DC power converter device (200) comprises a reactor (1), a contactor (2), an IGBT module (3), a fuse (4), a cooling fan (5), a protection board (6), a display device (7), a DC disconnector (8), an interface board (9), a control module (10), a communication board (11), a power distribution board (12) and an auxiliary power supply (13) and an MPPT circuit (14). The portable DC power converter device (200) along with the integration of the battery (80) is having the low power consumption with high efficiency. The portable DC power converter device (200) is supporting multiple converters in parallel with maximum current is greater than 10000 Ampere and similar DC-DC Power systems in parallel to feed the load of 20 MW or above as needed. Also, the portable DC power converter device (200) integrated with the battery (80) is safe and reliable device which is dust proof, moisture proof and capable to be workable in all kind of environment conditions.

Referring to FIG. 6 and FIG. 7, the electrolyzers (55) receives a direct DC power output (50) from the renewable based DC-to DC power conversion system (100) thereby ensuring carbon neutrality while producing hydrogen. As in the recent times, the trend of hydrogen is emerging as one form of renewable energy source. Since hydrogen is having a potential to be developed as an alternate or substitute of the fuel resources in industries like Ammonia, automotive, power, steel, aluminum, other metal etc. With the present invention, the hydrogen is evolving as the strong alternate or substitute of the fuel resources Because with the present invention, the usage of hydrogen is achieved while having the net zero condition. Thus, by incorporating the DC-to DC power conversion system (100) all the hydrogen generation projects are transforming as the green hydrogen projects. Because the hydrogen generation from the electrolyzers (55) is happening through green means. As the DC power output (50) received by the electrolyzers (55) is coming from a renewable source-based DC input (21).

Further, referring to FIG. 1 to FIG. 3 and FIG. 6 and FIG. 7, typically the solar power plants include at-least one or multiple solar panels (86, 87). The solar panels (86, 87) produces DC power input (21). After production of DC power input (21), the DC power input (21) is collected in a DC array box (not shown). From the box the DC power input (21) goes to a solar or PV converter which converts the DC power input (21) into the AC power input. Then in the end for supplying the power to the electrolyzer (55), the AC power is converted into DC power output (50). Typically, this whole conversion from DC power input to AC power input and then AC power output to DC power output (50) wasted 5% of overall electricity. However, with the present invention, the DC-to DC power conversion system (100) eliminates the step of DC power input to AC power input and then AC power output to DC power output (50) thereby saving overall energy. The DC power output (50) given to the electrolyzer (55) also contributes in reduction of the pollution. Thus, with the present invention, such type of solar plants integrated with the electroyzers (55) are developed which directly receive the DC power from the at-least one solar panel (86, 87).

Further, the present invention of the DC-to DC power conversion system (100) eliminates or substantially reduce the transmission and distribution losses and also reduces the capital investment cost by replacing six components into just one component i.e., DC-to DC power conversion system (100). Hence, the present invention having the economic and single unit DC-to DC power conversion system (100) for ensuring the highest efficient power conversion in most optimized time period. With the similar approach, the present invention provides an efficient DC-to DC power conversion system (100) to be used in the Renewable Energy, Industrial, IT and telecom Industry.

Moreover, referring to FIG. 7, with the present invention of the DC-to DC power conversion system (100) helps in developing the electroyzers (55) without any in-build rectifier in the electroyzers (55). As there is no need to convert AC power output to the DC power output. Also, the efficiency of the electroyzers (55) is improved along with the reliability of the electrolyzers. The present invention also helps in reducing cost of electrolyzers with the removal of the in-built rectifier blocks.

The present invention ensures direct DC-DC power conversion to convert 250 KW, 500 KW, 1 MW, 3 MW, 5 MW and 20 MW without involving any kind of AC conversion thereby saving huge electric power losses. Any of the other ratings of the DC-DC Power supply can be produces with the same methodology based on the electrolyzers input power load requirements.

The present invention makes the DC power coming out from renewable sources of energy as reliable by ensuring continuous supply of power irrespective of variation in nature affecting the renewable sources of energy.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

We claim:

1. A DC-to-DC power conversion system (100) comprising:
at least one renewal energy-based first input source to provide a first DC input (21);
a rechargeable energy storage device adapted to provide an auxiliary DC input (22);
a switching module (25) in electrical communication with each of the renewal energy-based first input source and the rechargeable energy storage device to receive the first DC input (21) and the auxiliary DC input (22) respectively, and provide a switching module DC output (60),
a boost module (30) in electrical communication with the switching module DC output (60), the boost module (30) having a control circuitry; and
characterized in that:
the control circuitry comprises a plurality of switching elements (K1, K2, Q1, Q2, Q3, and Q4) arranged in series or parallel; each of the plurality of switching elements (K1, K2, Q1, Q2, Q3, and Q4) is adapted to be controlled individually and independently of one another, and each of the plurality of switching elements includes IGBT power modules components/devices (Q1, Q2, Q3, and Q4);
a control module (10) for controlling each of the switching module (25) and the boost module (30),
wherein the control module (10) being adapted to operate the switching module (25) to selectively enable charging of the rechargeable energy storage device from the renewal energy-based first DC input (21), and
wherein the control module (10) being adapted to control the boost module (30) based on the magnitude of first DC input (21) from the renewal energy-based first input source, to selectively operate the plurality of switching elements (K1, K2, Q1, Q2, Q3, and Q4) and provide an output therefrom acting as an input to an external DC load (50).

2. The DC-to-DC power conversion system (100) as claimed in claim 1, comprises a measurement module adapted to continuously measure the magnitude of the first DC input (21), and the switching module DC output (60), the measurement module (25) being in communication with the control module (10).

3. The DC-to-DC power conversion system (100) as claimed in claim 2, wherein when the magnitude of the first DC input (21) is measured to be in a first input range, the control module (10) operates the switching module (25) such that all of the first DC input (21) is passed to the boost module (30) as the switching module DC output (60).

4. The DC-to-DC power conversion system (100) as claimed in claim 3, wherein when the magnitude of the first DC input (21) is measured to be in a second input range, the control module (10) operates the switching module (25) such that all of the first DC input (21) and the auxiliary DC input (22) is passed to the boost module (30) as the switching module DC output (60).

5. The DC-to-DC power conversion system (100) as claimed in claim 4, wherein when the magnitude of the first DC input (21) is measured to be in a third input range, the control module (10) operates the switching module (25) such that a first portion of the first DC input (21) is passed to the boost module (30) as the switching module DC output (60) and a second portion of the first DC input (21) is passed to the rechargeable Bi-directional energy storage batteries/device.

6. The DC-to-DC power conversion system (100) as claimed in claim 5, wherein based on the value of the switching module DC output (60), the switching elements of the boost module (30) are operated such that the output therefrom is at least at a threshold value required by the external DC load (50).

7. The DC-to-DC power conversion system as claimed in claim 5, wherein when the value of the switching module DC output (60) is measured to be in a first output range, all of the switching elements of the plurality of switching elements are closed whereby all of the switching module DC output (60) is boosted to reach at least at a threshold value required by the external DC load (50).

8. The DC-to-DC power conversion system (100) as claimed in claim 5, wherein when the value of the switching module DC output (60) is measured to be in a second output range, a set of switching elements are opened whereby a portion of the switching module DC output (60) is boosted to reach at least at a threshold value required by the external DC load (50).

9. The DC-to-DC power conversion system (100) as claimed in claim 5, wherein the renewal energy-based first input source is one of solar and wind energy based.

10. The DC-to-DC power conversion system (100) as claimed in claim 5, wherein the external DC load (50) is a Hydrogen electrolyzer and any of the industrial, telecom or Data center loads.

11. A method of DC-to-DC power conversion, the method comprising:
receiving a first DC input (21) from a renewal energy-based first input source based on generation of the first DC input (21) from one of solar and wind energy;
receiving an auxiliary DC input (22) from a rechargeable energy storage device based on selectively charging of the rechargeable energy storage device from the renewal energy-based first DC input (21);
measuring values, via a measurement module, of the first DC input (21), and the auxiliary DC input (22);
passing one or more of the first DC input (21), and the auxiliary DC input (22) to a boost module (30), characterized in that based on the measurement of the magnitude of the first DC input (21), when the magnitude of the first DC input (21) is measured to be in a first input range, operating a switching module (25) to pass all of the first DC input (21) to the boost module (30) as the switching module DC output (60), when the magnitude of the first DC input (21) is measured to be in a second input range, operating the switching module (25) to pass all of the first DC input (21) and the auxiliary DC input (22) the boost module (30) as the switching module DC output (60), and when the magnitude of the first DC input (21) is measured to be in a third input range, operating the switching module (25) to pass a first portion of the first DC input (21) to the boost module (30) as the switching module DC output (60) and passing a second portion of the first DC input (21) to the rechargeable Bi-directional energy storage batteries/device,
the boost module having a plurality of switching elements (K1, K2, Q1, Q2, Q3 and Q4) arranged in series or parallel, wherein each of the plurality of switching elements (K1, K2, Q1, Q2, Q3, and Q4) is adapted to be controlled individually and independently of one another, and each of the plurality of switching elements includes IGBT power modules components/devices (Q1, Q2, Q3, and Q4); and in that,
operating the plurality of switching elements (K1, K2, Q1, Q2, Q3 and Q4), based on a threshold value required by an external DC load (50), to boost the one or more of the first DC input (21) and the auxiliary DC input (22), passing there through; and
providing the threshold value to the external load (50).

12. The method as claimed in claim 11, wherein the step of operating switching elements includes operating a set of switching elements of the plurality of switching elements (K1, K2, Q1, Q2, Q3, and Q4) periodically for a predetermined period of time, so that output therefrom is at least at a threshold value required by the external DC load (50).
